(19) United States
(12) Patent Application Publication
(10) Pub. No.: US 2004/0030724 A1
(43) Pub. Date: Feb. 12, 2004

(54) Computer-implemented method and system for replenishing material inventories

(76) Inventors: Edward G. Rosenquist, Plymouth, MI (US); Brian Dziadzio, Dearborn, MI (US)

Correspondence Address: BROOKS KUSHMAN P.C./FGTL, 1000 TOWN CENTER, 22ND FLOOR, SOUTHFIELD, MI, 48075-1238, US

(21) Appl. No.: 10/464,352

(22) Filed: Jun. 18, 2003

Related U.S. Application Data
(60) Provisional application No. 60/389,846, filed on Jun. 19, 2002.

(51) Int. Cl. G06F 7/00

(52) U.S. Cl. 707/104.1

(57) ABSTRACT

One aspect of the present invention is a computer-implemented method for replenishing inventory materials. In general, the method is comprised of selectively permitting access to a material database by a supplier having a supplier catalog, receiving item information for a plurality of items from the supplier catalog and updating the material database based on the item information for the plurality of items to obtain an updated material database through an inventory blanket link tool interface. The inventory blanket link tool interface possesses functionality to create an at least one blanket line for each of the plurality of items. The item information for each item can include, but is not limited to, a manufacturer part, a material price, and a unit of measure. The updated material database can be relied upon by suppliers and buyers to replenish inventory material levels.

### CROSS-REFERENCE TO RELATED APPLICATION

This application claims the benefit of U.S. Provisional Application Serial No. 60/389,846, filed Jun. 19, 2002, and entitled “Method and System for Replenishing Material Inventories.”

### BACKGROUND OF THE INVENTION

1. Field of the Invention

One of the aspects of the present invention relates generally to a method and system of replenishing material inventories and, more specifically, a method and system of replenishing indirect material inventories.

2. Background Art

A distributed enterprise refers to an organization having multiple operations spread across multiple geographic regions, including continents and the entire world. Distributed enterprises commonly have plants spread across multiple geographic regions. On a continuing basis, these plants need to replenish their indirect materials inventory. Indirect materials include resources that are necessary to bring about the manufacture of the product. In an automobile-manufacturing example, an indirect material might include a day-to-day commodity such as wrenches or safety glasses that, although not technically a part of the automobile, are indirectly necessary to manufacture the automobile.

Replenishing indirect material inventories in distributed enterprises presents a unique challenge to conventional electronic procurement management software. Most procurement systems are tailored to effectively meet the needs of smaller to mid-sized businesses that operate in a limited geographic region. These conventional systems lack functionality to effectively support certain business needs of distributed enterprises that replenish indirect material inventories for plants in multiple geographic regions.

Traditionally, electronic data interchange (EDI) and virtual private network (VPN) technologies have enable businesses and their suppliers to exchange invoices, purchase orders, and other documents to conduct their day-to-day business online. Typically, these systems were proprietary in nature, required a dedicated technical infrastructure, and required a costly subscription or pay-per-use access arrangement.

The advent of the Internet has revolutionized electronic procurement systems by increasing the speed and decreasing the cost associated with the first-generation systems. Without such access barriers, buyers are presented with a broader horizon of potential suppliers. Today, a buyer organization can access the Internet to obtain pricing information, product and service information, submit a purchase request, route the request for approval, view the fulfillment status of the request, receive a receipt and delivery notification, and transmit payment.

According to one IDC survey conducted in September 2000, the amount of savings generated with the use of an Internet-enabled procurement system will, on average, range from 5.0% to 8.5% of a company's purchasing budget. Depending on the size of the company, this savings can translate to over a billion dollars annually.

Today, distributed enterprises, such as General Electric and Compaq Computer, have integrated electronic procurement systems to streamline the online sourcing and purchasing of direct and indirect materials. For example, Compaq Computer employees can use their Web browser to view an online supplier catalog of over 37,000 items, and easily purchase the resources necessary to satisfy their day-to-day needs. Companies such as Compaq can expand this functionality to increase the variety of resources available, rationalize its supply base, and consolidate its supply chain in an effort to leverage purchase volumes into fewer suppliers and improve its relationship with a preferred supply base.

One electronic procurement application is Oracle Procurement. A more detailed description of the Oracle Procurement application can be found at www.oracle.com. Other developers of procurement solutions include Ariba (www.ariba.com), i2 (www.i2.com), CommerceOne (www.commerceone.com), SAP (www.sap.com) and PeopleSoft (www.peoplesoft.com).

Issued U.S. patents relating to electronic procurement applications and systems include U.S. Pat. No. 5,970,475 to Barnes et al. and U.S. Pat. No. 6,363,365 to Kou. Published U.S. patent applications relating to electronic procurement applications and systems include U.S. Patent Application No. 2001/0042050 to Fletcher et al. Additional information relating to electronic procurement systems includes Albert Pang's IDC White Paper eProcurement Ensures Visionary Companies a Place in the New Economy, July 2001.

Although today's procurement systems may be comprehensive and beneficial, the systems suffer from certain disadvantages relating to the replenishment of indirect materials inventory. For example, under current systems distributed enterprise buyers enter and maintain Blanket Purchase Agreements manually. Manual entry is highly inefficient and therefore decreases the buyer's productivity.

Purchasing departments in distributed enterprises need indirect material pricing maintained by suppliers to free buyers from having to keep prices on non-strategic commodities updated. There is a need to provide a method and system to automatically create blanket purchase agreement lines and update prices using information provided by e-catalogs, thereby eliminating buyer intervention.

### SUMMARY OF THE PRESENT INVENTION

One aspect of the present invention is a computer-implemented method for replenishing materials. The method is comprised of selectively permitting access to a material database by a supplier having a supplier catalog; receiving item information for a plurality of items from the supplier catalog, and updating the material database based on the item information for the plurality of items to obtain an updated material database through an inventory blanket link tool interface. The item information can include manufacturer part number, a material price and a unit of measure, the inventory blanket link tool interface can possess functionality to create an at least one blanket line for each of the plurality of items. In certain embodiments, the updated material database is relied upon by suppliers and buyers to replenish inventory material levels.

In certain embodiments, the item information for each item includes a supplier name and a manufacturer name. A method of the present invention can further comprise carrying out min/max planning based on the updated material database. In addition, a method can include initiating a part specification process. Moreover, a method can include receiving the at least one blanket line for each of the plurality of items. Moreover, the at least one blanket line for at least one of the plurality of items can be corrected.

Another aspect of the present invention relates to a computer-implemented system for replenishing inventory materials. The system can comprise at least one buyer computer for communicating with an at least one supplier computer and a material database in communication with the at least one buyer computer. The at least one buyer computer can be configured to selectively permit access to a material database by a supplier having a supplier catalog, receive item information for a plurality of items from the supplier catalog and update the material database based on the item information for the plurality of items to obtain an updated material database through an inventory blanket link tool interface. The item information can include manufacturer part number, material price, and unit of measure. The blanket link tool interface can possess functionality to create an at least one blanket line for each of the plurality of items. The material database can be relied upon by buyers and suppliers to replenish inventory material levels.

In certain embodiments, the item information for each item can include a supplier name and a manufacturer name. The inventory blanket link tool interface can possess functionality to at least partially manage the material database by a supplier. The inventory blanket tool interface can also possess functionality to carry out min/max planning based on the updated material database. The at least one buyer computer can be further configured to initiate a part specification process. In certain embodiments, the plurality of items can be comprised of either a plurality of inventory items or a plurality of expense items. The blanket link tool can possess functionality to create a blanket purchase order header for a supplier. The manufacturer part number can be comprised of a normalized manufacturer part number.

In certain embodiments, the system can further comprise an item master database. The item master database can be comprised of item master information for a plurality of items. The item master information for each item can be comprised of a manufacturer name, a normalized manufacturer part number, and a unit of measure. The inventory blanket link tool can possess functionality to compare the manufacturer name, the normalized manufacturer part number, and the unit of measure for at least one item in the item master database with the manufacturer name, the normalized manufacturer part number and the unit of measure for at least one item in the material database. The item master information can include a master corporate catalog for each item. The inventory blanket link tool can possess functionality to create a line item in the blanket purchase order header based on the master corporate catalog number for at least one item. The inventory blanket link tool can possess functionality to create a requisition. The blanket link tool can possess functionality to cause display of the blanket purchase order header. The at least one buyer computer can be further configured to preclude a buyer from revising the material price in the material database.

According to another aspect of the present invention, a computer-implemented system for replenishing inventory materials is disclosed. The system can be comprised of at least one supplier computer for communicating with an at least one buyer computer and a material database and communication with the at least one supplier computer. The at least one supplier computer can be configured to receive an access notification for accessing a material database by a supplier having a supplier catalog, transmit item information for a plurality of items from the supplier catalog, and update a material database based on the item information for the plurality of items to obtain an updated material database through an inventory blanket link tool interface. The item information for each item is comprised of a manufacturer part number, a material price, and a unit of measure. The inventory blanket link tool interface can possess functionality to create an at least one blanket line for each of the plurality of items. The updated material database can be relied upon by buyers and suppliers to replenish inventory material levels.

In another aspect of the present invention, a computer-readable product for use in conjunction with replenishing inventory materials is disclosed. The product can be produced by a computer-implemented process. The process can include receiving item information for a plurality of items from a supplier catalog and storing the item information in a computer-readable product through an inventory blanket link tool interface. The item information can include a manufacturer part number, a material price, and a unit of measure for each item. The inventory blanket link tool interface can possess functionality to create an at least one blanket line for each of the plurality of items. The computer-readable product can be used in conjunction with suppliers replenishing inventory materials.

According to yet another aspect of the present invention, a program for controlling a buyer computer for replenishing inventory materials is disclosed. The program can comprise instructions for selectively permitting access to a material database by a supplier having a supplier catalog, instructions for receiving item information for a plurality of items from a supplier catalog and instructions for updating the material database based on the item information. The item information can be comprised of a manufacturer part number, a material price, and a unit of measure for each item to obtain an updated material database. The inventory blanket link tool interface can possess functionality to create an at least one blanket line for each of the plurality of items. The material database is relied upon by buyers and suppliers to replenish inventory material levels.

The above embodiments and other embodiments, features, and advantages of the present invention are readily apparent from the following detailed description of the best mode for carrying out the invention when taken in connection with the accompanying drawings.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may be best understood with reference to the following description, taken in connection with the accompanying drawings:

FIG. 1 is a block flow diagram illustrating an inventory blanket link overview in accordance with an embodiment of the present invention; and

FIG. 2 represents a schematic illustration of a computer-implemented system for implementing one embodiment of the present invention.

### DETAILED DESCRIPTION OF EMBODIMENTS OF THE PRESENT INVENTION

As required, detailed embodiments of the present invention are disclosed herein. However, it is to be understood that disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one of ordinary skill in the art to variously employ in the present invention.

### Inventory Blanket Link Overview

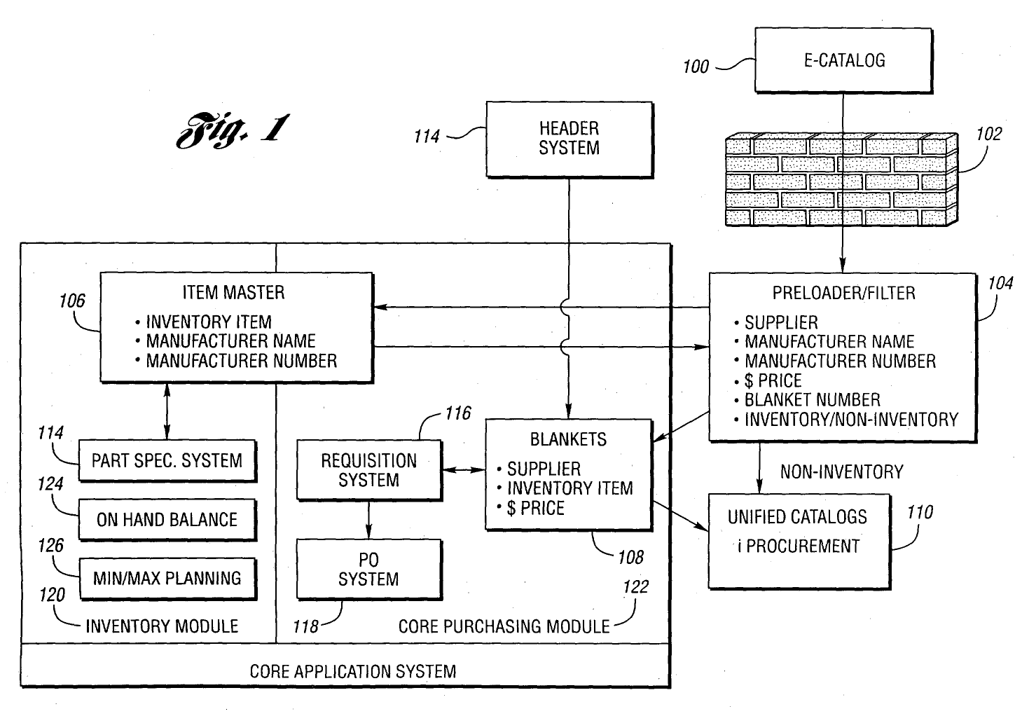

FIG. 1 is a block flow diagram illustrating an inventory blanket link overview in accordance with an embodiment of the present invention. The content and arrangement of objects illustrated in FIG. 1 can be rearranged, modified or omitted to best fit a particular implementation.

A material inventory replenishment process, otherwise referred to as an inventory blanket link is triggered when an e-Catalog service 100 transmits an updated e-catalog across firewall 102 to preloader module 104.

Preloader module 104 transmits material information to the item master 106 and the blankets 108. Material information can include, but is not limited to, supplier, manufacturer name, manufacturer number, price, blanket number, and whether the material is inventory or non-inventory. Preloader module 104 can transmit the manufacturer name and number to item master 106. The manufacturer name and number are validated against the item master 106. If the item master does not contain the manufacturer name and number, the material associated with that name and number is not used by the inventory blanket link. Once the material information is validated, the item master 106 transmits inventory item information to preloader module 104. If the material is non-inventory, the preloader module 104 transmits the material information to a unified catalog for iProcurement 110.

It should be understood that Item Master 106 refers to a specific inventory organization in which all items are defined. A business would usually only have one item master, but it is possible to create many if required. Items are first created in the item master then assigned to other inventory organizations. Each inventory organization would normally hold a sub-set of the items held in the item master.

Blankets 108 can create blanket purchase agreements. It should be understood that a Blanket Purchase Agreement (BPA) refers to a type of purchase order issued before actual delivery of goods or services is requested from the supplier. A BPA is normally created to document a long-term supplier agreement, and can contain an effective date and an expiration date, a committed amount, or quantity, price breaks. A BPA is used as a tool for specifying agreed prices and delivery dates for goods and services before ordering them.

Part Spec System 114 transmits material information for new or revised materials to item master 106.

It should be understood that a Requisition refers to an internal request for the purchasing department or buyer to procure goods or services to satisfy the originators requirements. A requisition can originate from an employee or from another process, such as inventory or manufacturing. Each requisition can include many lines, generally with a distinct item on each requisition line. Each requisition line includes at least a description of the item, the unit of measure, the quantity needed, the price per item, and the general ledger account to be charged for the item.

Requisitions System 116 transmits requisition information regarding a particular supplier to blankets 108 based on a request made by blankets 108. Requisitions System 116 also transmits requisition information to PO System 118.

Item Master 106 can be within inventory module 120 and a core purchasing module 122. Part Spec System 114, On Hand Balance 124, and Min/Max Planning 126 can be part of the inventory module 120. Requisitions System 116, PO System 118, and Blankets 108 can be part of core purchasing module 122. The inventory module 120 and the core purchasing module 122 can be built on core applications system 128.

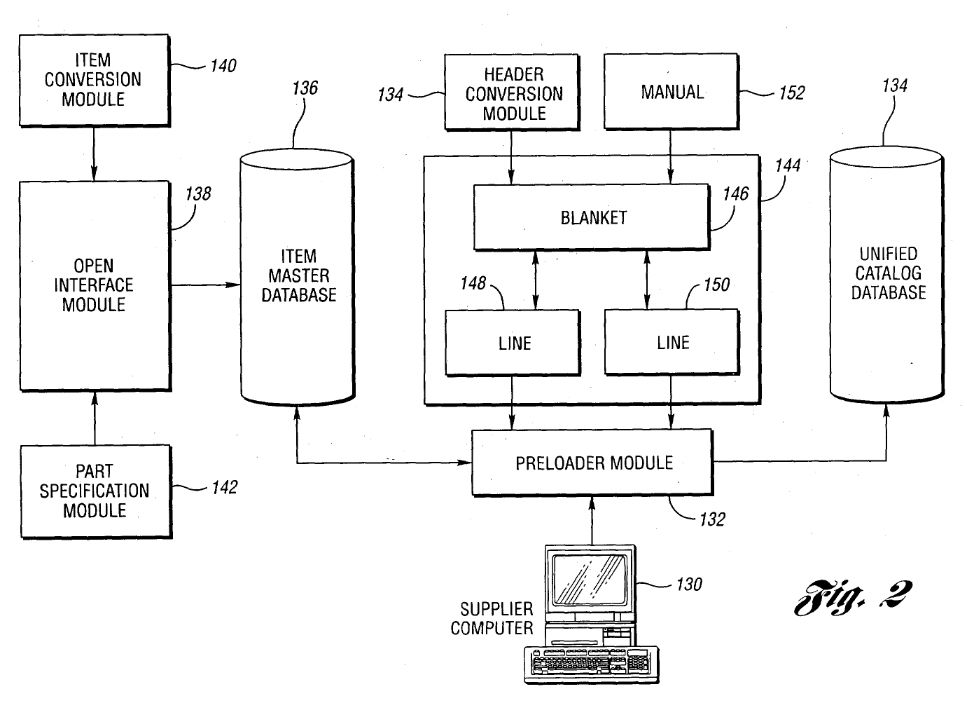

FIG. 2 represents a schematic illustration of a computer-implemented system for implementing one embodiment of the present invention. The content and arrangement of objects illustrated in FIG. 2 can be rearranged, modified or omitted to best fit a particular implementation.

Block 130 represents an at least one supplier computer, which transmits inventory item information to a preloader module 132. Preloader module can be responsible for creating expense items in a catalog and transmitting the catalog to the unified catalog database 134. Additionally, preloader module 132 can validate inventory items by interfacing with item master database 136. Unified catalog database can include, but is not limited to, the following data: items, categories, manufacturing name, manufacturing item, suppliers, price numbers, and BP numbers. Item master database 136 can include, but is not limited to, the following data: inventory item number, manufacturing name, and manufacturing part number. Item master database 136 can be proliferated with data through open interface module 138 which is fed information from item conversion module 140 for item conversion and part specification module 142 for new items.

Block 144 represents a blanket purchase order having blanket 146 and a plurality of blanket lines 148 and 150. Blanket 146 can include a header number and supplier information which can be provided manually as depicted in block 152 or through a header conversion module 154. Blanket lines 148 and 150 can include line number, inventory item, and price for inventory items. Blanket 144 can be responsible for creating inventory items catalog which is transmitted to unified catalog database 134.

### Inventory Blanket Link Tool Functionality

The inventory blanket link tool includes the ability to create blanket lines for all inventory items at plant launch.

The inventory blanket link tool includes the ability to create blanket lines for all inventory items added through the part specification process after launch.

The inventory blanket link tool includes the ability to update prices on blankets as supplier e-catalogs are updated.

The inventory blanket link tool includes the ability to remove items from the blanket by canceling line when supplier stop carrying items.

The inventory blanket link tool includes the ability to generate exception reports for buyers on inventory items that are not on supplier e-catalogs.

The inventory blanket link tool includes the ability to create a new line on the supplier blanket agreement for items in the e-catalog when a new item is added to the item master through part specification process.

### Implementation of the Inventory

### Blanket Link Tool Functionality

According to one embodiment of the present invention, a system is disclosed that includes developing customized components that are compatible with an existing Oracle Module.

The disclosed system of implementing the aspects of the present invention includes the following modifications to the Oracle Module:

Blanket headers can be created for suppliers who provide their e-catalogs.

Blankets can utilize a Coverage eForm in place of Oracle sourcing rules. This eForm assigns coverage groups to a blanket, which indicate the plants and facilities belonging to the coverage groups, which can use the blanket.

Relevant suppliers and their sites can be entered in the coverage eForm. There will be one supplier on the blanket header and one or more distributors on the coverage eForm. If there is not a supplier listed on the coverage form, the supplier on the header should be used.

It should be understood that a Form refers to a predefined grouping of functions, called from a menu and displayed, if necessary, on several windows. A Form is a logical collection of blocks, regions and fields that appears on a single screen. Oracle Applications forms resemble paper forms used to run a business. Data is entered by typing information into the form.

All inventory items in the Item Master can be priced in the supplier e-catalogs. Exceptions can be reported to buyers.

Suppliers provide their catalog information to the e-catalog provider. The e-catalog provider can filter the information and can send out e-catalogs and price files. The e-catalog provider can check for a valid Supplier and Manufacturer Name and ensures that the Blanket Number and Manufacturer Number fields are populated on the e-catalog.

Buyers create blankets and advise the suppliers to include the blanket number on the appropriate price file. Buyers can review the suppliers' price files for the correct blanket number before e-catalog updates.

When Min-Max or other applicable replenishment planning is run for plant inventory items, requisitions can be created automatically. The requisitions can transform to Standard Purchase orders against the appropriate supplier utilizing the Blanket agreements and coverage. If an item cannot be found on the blanket with appropriate coverage, the requisition can be forwarded to a buyer for intervention.

Inventory item information like Manufacturer Name, Manufacturer Part Number, and Unit of Measure (UOM) can be stored and maintained in the part specification table.

In certain embodiments, a system is disclosed that includes the following business guidelines:

Buyers can maintain the coverage of each blanket agreement manually. The Blanket agreement can be created for a Supplier. The coverage can determine all the supplier sites that are attached to the agreement. The coverage can determine all the regions and plants that can procure utilizing the Blanket agreement.

Once Items are set up on catalogs, users can procure items utilizing Internet procurement as expense items and planning requisitions as standard inventory items.

Buyers are responsible to review exception reports and take necessary actions to fix them.

Once the item is set up on a catalog, users can purchase the item on expense or through inventory core requisitions without Purchasing involvement.

The e-catalog provider can use the manufacturer name list as a standard to alter the Manufacturers names in the supplier e-catalogs.

If an item is not in the Item Master, the plant personnel can (1) search the iProcurement catalog, (2) submit an expense requisition if the item is in the e-catalog, (3) submit a free form requisition if the item is not in the catalog, and (4) work with a tooling engineer to complete the part specification process to add the item to the Item Master.

If an item is already in the Item Master but an order cannot be placed, the plant personnel can (1) conduct a spot buy by submitting a free form requisition, (2) indicate on the form to the buyer whether this is an item to be inventoried, and (3) notify the buyer's work list indicating that a free form requisition has been processed.

If an item is not on the blanket with proper coverage, the requisition can be sent to the buyer for management of the blanket.

The buyer's responsibility can review why the plant was unable to place the order and decide upon the appropriate action to allow plants to order the item for their inventory. Remedies can include: (1) the requested item can be added to an authorized supplier's e-catalog and (2) allow plant coverage on a specific blanket.

In one embodiment of the present invention, a system is disclosed for automatically updating prices. The system includes: (1) core Inventory holds Manufacturers name and part number in custom part specification table FMCINV_PART_SPECIFICATION, (2) custom coverage information is stored in FMC_PO_HEADERS_EXTENSION table, (3) iProcurement e-catalog holds Manufacturers name and part number in table ICX_POR_ITEMS in columns A4 and A5, (4) Supplier Name and Supplier Identification GSDB Code can be stored in table ICX_POR_ITEMS in columns A1 and A2, (5) iProcurement e-catalog Prices are stored in tables ICX_POR_PRICE_LISTS and ICX_POR_PRICE_LIST_LINES, and (6) Oracle Purchasing Documents Open Interface Application Program Interface (API) can be used to create Blanket Agreement lines for the Indirect Inventory Items.

A system is also disclosed to provide the ability to automatically load Blanket agreement lines and price updates. The system includes: (1) providing a flat file with Valid Manufacturers Name, (2) storing a catalog and price file a staging area, (3) checking each item on the file against the Item Master to determine whether it is an inventory item and matches made via Manufacturer Name, Manufacturer Part Number, and Unit of Measure (UOM) are stored in the Part specification tables, (4) creating a line on the appropriate supplier blanket with item and price information per the blanket number on the price file if the item is an inventory part, (5) updating the price if the item line already exists on the appropriate supplier blanket, (6) creating a Unified Catalog for the all the items in the item master with blanket information, (7) automatically entering non-inventory items in the unified catalog via the catalog loader, and (8) loading inventory items in the unified catalog after writing to the blanket.

According to certain embodiments of the present invention, a system is disclosed to provide the ability to generate exception reports for buyers on inventory items that are not on supplier e-catalogs. If (1) a new item or converted item is in the item master but not in the e-catalogs or (2) an item is in the item master but not in any blanket agreement, then an exception report can be generated that includes the Item Number, Manufacturer Name, Manufacturer Part Number, UOM, Plant Code, and Reason Code. If (1) an item is inactivated in the item master or (2) the plant is not covered by blanket although coverage exists for another plant, then an exception report can be generated that includes the Item Number, Manufacturer Name, Manufacturer Part Number, UOM, Plant Code, and Reason Code. The system further includes the ability to create an initial load report that includes the Item Number, Supplier, Manufacturer Name, Manufacturer Part Number, Unit of Measure (UOM), Plant Code, Item Master Global Description, and Blanket Number that were matched and added to a blanket.

A system is also disclosed to provide the ability to add new items. The system includes adding a new item to the item master through the part specification process, populating a staging table alerting the IBL about new items, reviewing the staging table, and creating supplier agreement lines for those items. If the item does not exist in any e-catalog, an exception report can be provided to the buyer for review.

While the best mode for carrying out the invention has been described in detail, those familiar with the art to which this invention relates will recognize various alternative designs and embodiments for practicing the invention as defined by the following claims.

What is claimed:

1. A computer-implemented method for replenishing inventory materials, the method comprising:
selectively permitting access to a material database by a supplier having a supplier catalog;
receiving item information for a plurality of items from the supplier catalog, the item information for each item being comprised of a manufacturer part number, a material price, and a unit of measure; and
updating the material database based on the item information for the plurality of items to obtain an updated material database through an inventory blanket link tool interface possessing functionality to create an at least one blanket line for each of the plurality of items,
whereby the updated material database is relied upon by buyers and suppliers to replenish inventory material levels.

2. The method of claim 1 wherein the item information for each item includes a supplier name and a manufacturer name.

3. The method of claim 2 further comprising carrying out min/max planning based on the updated material database.

4. The method of claim 3 further comprising initiating a part specification process.

5. The method of claim 1 further comprising receiving the at least one blanket line for each of the plurality of items.

6. The method of claim 5 further comprising selectively correcting the at least one blanket line for at least one of the plurality of items.

7. A computer-implemented system for replenishing inventory materials, the system comprising at least one buyer computer for communicating with an at least one supplier computer and a material database in communication with the at least one buyer computer, the at least one buyer computer configured to:
selectively permit access to a material database by a supplier having a supplier catalog;
receive item information for a plurality of items from the supplier catalog, the item information for each item being comprised of a manufacturer part number, a material price, and a unit of measure; and
updating of material database based on the item information for the plurality of items to obtain an updated material database through an inventory blanket link tool interface wherein the inventory blanket link tool interface possessing functionality to create an at least one blanket line for each of the plurality of items,
whereby the updated material database is relied upon by buyers and suppliers to replenish inventory material levels.

8. The system of claim 7 wherein the item information for each item includes a supplier name and a manufacturer name.

9. The system of claim 7 wherein the inventory blanket link tool interface possesses functionality to at least partially manage the material database by a supplier.

10. The system of claim 7 wherein the inventory blanket link tool interface possesses functionality to carry out min/max planning based on the updated material database.

11. The system of claim 7 wherein the at least one buyer computer is further configured to initiate a part specification process.

12. The system of claim 7 wherein the plurality of items are comprised of a plurality of inventory items.

13. The system of claim 7 wherein the plurality of items are comprised of a plurality of expense items.

14. The system of claim 7 wherein the inventory blanket link tool possesses functionality to create a blanket purchase order header for a supplier.

15. The system of claim 14 wherein the manufacturer part number is comprised of a normalized manufacturer part number.

16. The system of claim 15 wherein the system further comprises an item master database, the item master database being comprised of item master information for a plurality of items, the item master information for each item being comprised of a manufacturer name, a normalized manufacturer part number and a unit of measure.

17. The system of claim 16 wherein the inventory blanket link tool possesses functionality to compare the manufacturer name, the normalized manufacturer part number and the unit of measure for at least one item in the item master database with the manufacturer name, the normalized manufacturer part number and the unit of measure for at least one item in the material database.

18. The system of claim 17 wherein the item master information includes a master corporate catalog number for each item.

19. The system of claim 18 wherein the inventory blanket link tool possesses functionality to create a line item in the blanket purchase order header based on the master corporate catalog number for at least one item.

20. The system of claim 19 wherein the inventory blanket link tool possesses functionality to create a requisition.

21. The system of claim 20 wherein the inventory blanket link tool possesses functionality to cause display of the blanket purchase order header.

22. The system of claim 7 wherein the at least one buyer computer is further configured to preclude a buyer from revising the material price in the material database.

23. A computer-implemented system for replenishing inventory materials, the system comprising at least one supplier computer for communicating with an at least one buyer computer and a material database in communication with the at least one supplier computer, the at least one supplier computer configured to:
receive an access notification for accessing a material database by a supplier having a supplier catalog;
transmit item information for a plurality of items from the supplier catalog, the item information for each item being comprised of a manufacturer part number, a material price, and a unit of measure; and
update the material database based on the item information for the plurality of items to obtain an updated material database through an inventory blanket link tool interface wherein the inventory blanket link tool interface possessing functionality to create an at least one blanket line for each of the plurality of items,
whereby the updated material database is relied upon by buyers and suppliers to replenish inventory material levels.

24. A computer-readable product for use in conjunction with replenishing inventory materials, the product being produced by a computer-implemented process, the process comprising:
receiving item information for a plurality of items from a supplier catalog, the item information for each item being comprised of a manufacturer part number, a material price, and a unit of measure; and
storing the item information in a computer-readable product through an inventory blanket link tool interface wherein the inventory blanket link tool interface possessing functionality to create an at least one blanket line for each of the plurality of items,
whereby the computer-readable product is used in conjunction with suppliers replenishing inventory materials.

25. A program for controlling a buyer computer for replenishing inventory materials, the program comprising:
instructions for selectively permitting access to a material database by a supplier having a supplier catalog;
instructions for receiving item information for a plurality of items from a supplier catalog, the item information for each item being comprised of a manufacturer part number, a material price, and a unit of measure; and
instructions for updating the material database based on the item information for the plurality of items to obtain an updated material database through an inventory blanket link tool interface possessing functionality to create an at least one blanket line for each of the plurality of items,
whereby the updated material database is relied upon by buyers and suppliers to replenish inventory material levels.
